(19) United States
(12) Patent Application Publication
(10) Pub. No.: US 2012/0042130 A1
(43) Pub. Date: Feb. 16, 2012

(54) Data Storage System

(76) Inventor: Aaron Antony Peapell, Brighton-le-Sands (AU)

(21) Appl. No.: 13/265,919

(22) PCT Filed: Apr. 23, 2010
(86) PCT No.: PCT/AU2010/000475

§ 371 Date: Oct. 24, 2011

(30) Foreign Application Priority Data
Apr. 24, 2009 (AU) 2009901787

(51) Int. Cl. G06F 12/08

(52) U.S. Cl. 711/126; 711/E12.019

(57) ABSTRACT

A data storage system includes a host computing system having a data storage server and a local cache. The host computing system has access via an internet connection to a data account with a cloud data storage provider. A data management protocol is stored on, and adapted to be employed by, the host computing system. The protocol directs the data storage server to store current data in the local cache and dormant data in the data account of the cloud data storage provider.

### RELATED APPLICATIONS

This application claims the benefit of international application PCT/AU2010/000475, having an international filing date of Apr. 23, 2010 and published as WO 2010/121330.

### FIELD OF THE INVENTION

The present invention relates to a data storage system for storing electronic data and in particular, to a data storage system utilising cloud data storage.

### BACKGROUND OF THE INVENTION

Storing extremely large volumes of information on a local area network (LAN) is expensive. High capacity electronic data storage devices like file servers, Storage Area Networks (SAN) and Network Attached Storage (NAS) provide high performance, high availability data storage accessible via industry standard interfaces. However, electronic data storage devices have many drawbacks, including that they are costly to purchase, have limited lifetimes, require backup and recovery systems, have a physical presence requiring specific environmental conditions, require personnel to manage and consume considerable amounts of energy for both power and cooling.

Cloud data storage providers, such as AmazonS3, provide cheap, virtually unlimited electronic data storage in remotely hosted facilities. Information stored with these providers is accessible via the internet or Wide Area Network (WAN). Economies of scale enable providers to supply data storage cheaper than the equivalent electronic data storage devices.

Cloud data storage has many advantages. It's cheap, doesn't require installation, doesn't need replacing, has backup and recovery systems, has no physical presence, requires no environmental conditions, requires no personnel and doesn't require energy for power or cooling. Cloud data storage however has several major drawbacks, including performance, availability, incompatible interfaces and lack of standards.

Performance of cloud data storage is limited by bandwidth. Internet and WAN speeds are typically 10 to 100 times slower than LAN speeds. For example, accessing a typical file on a LAN takes 1 second, accessing the same file in cloud data storage may take 10 to 100 seconds. While consumers are used to slow internet downloads, they aren't accustomed to waiting long periods of time for a document or spreadsheet to load.

Availability of cloud data storage is a serious issue. Cloud data storage relies on network connectivity between the LAN and the cloud data storage provider. Network connectivity can be affected by any number of issues including global networks disruptions, solar flares, severed underground cables and satellite damage. Cloud data storage has many more points of failure and is not resilient to network outages. Network outages mean the cloud data storage is completely unavailable.

Cloud data storage providers use proprietary networking protocols often not compatible with normal file serving on the LAN. Accessing cloud data storage often involves ad hoc programs to be created to bridge the difference in protocols.

The cloud data storage industry doesn't have a common set of standard protocols. This means that different interfaces need to be created to access different cloud data storage providers. Swapping or choosing between providers is complicated as their protocols are incompatible.

It is an object of the present invention to substantially overcome or at least ameliorate one or more of the above disadvantages, or to provide a useful alternative.

### SUMMARY OF THE INVENTION

In a first aspect, the present invention provides a data storage system having:

a host computing system including a data storage server and a local cache, the host computing system having access via an internet connection to a data account with a cloud data storage provider; and

a data management protocol stored on, and adapted to be employed by, the host computing system to direct the data storage server to:
(a) store data to be saved in the local cache;
(b) periodically analyse data on the local cache and identify dormant data that has not been accessed for a given period of time;
(c) copy dormant data to the data account of the cloud data storage provider and delete the copied dormant data from the local cache;
(d) flag individual units of the data as “online” for data units stored in the local cache or “offline” for data units stored in the data account of the cloud data storage provider;
(e) accelerate read requests for data flagged as “offline” by accessing the data from the data account with the cloud data storage provider with read ahead caching; and
(f) accelerate write requests to dormant data flagged as “offline” by storing delayed writes in the local cache and periodically applying the delayed writes to the dormant data by updating the data stored in the data account of the cloud data storage provider and storing the updated data on the local cache.

In a preferred embodiment, the data storage system further includes at least one user terminal and a virtual hard drive device driver installed on the user terminal, the virtual hard drive device driver being adapted to map a virtual hard drive on the data storage server.

Preferably, the host computing system includes at least one file server and a network file system installed on the file server, the network file system being adapted to map a virtual file share on the data storage server.

Further preferably, the data management protocol is adapted to be employed by the host computing system to direct the data storage server to delete accessed data from the data account of the cloud data storage provider when data has been accessed by a read request, stored on the local cache and flagged as “online”.

The data management protocol is preferably adapted to be employed by the host computing system to direct the data storage server to accelerate read requests for uninitialized data by returning “all zeros”.

Preferably, the data management protocol is adapted to be employed by the host computing system to direct the data storage server to accelerate write requests of “all zeros” to uninitialized data by ignoring the request.

Further preferably, the data management protocol is adapted to be employed by the host computing system to direct the data storage server to accelerate read requests for data flagged as “offline” and having associated delayed write data, by applying the delayed write data from the local cache, flagging the data as “online” and deleting the data from the data account of the cloud data storage provider.

In a preferred embodiment, the data storage system further comprises a data storage accelerator provided on a local network computer, the data storage accelerator being adapted to process requests from the data storage server to save data by storing the data on a local hard disk of the local network computer and to process subsequent requests to send data by returning the data from the local hard disk of the local network computer.

Preferably, the data storage accelerator is further adapted to process requests to send or check for data with a specific hash by:
a) returning either the requested data or a positive acknowledgement to the data storage server, if the requested data is stored in the local hard disk and the hash of the data stored in the local hard disk matches the hash of the data requested; and
b) deleting the requested data from the local hard disk, if the requested data is stored in the local hard disk and the hash of the data stored in the local hard disk does not match the hash of the data requested.

The data storage system preferably further comprises a data storage optimiser provided on the user terminal and having access to the virtual hard drive to optimise the data stored on the local cache. Alternatively, the data storage system further comprises a data storage optimiser provided on the file server and having access to the virtual file share to optimise the data stored on the local cache.

Preferably, the data storage optimiser is adapted to periodically read virtual hard drive or virtual file share metadata including directories, filenames, permissions and attributes. Further preferably, the data storage optimiser is adapted to accelerate performance of the data storage server by preventing data other than file data from being identified as dormant. Further preferably, the data storage optimiser is adapted to reduce storage requirements of the data storage server by periodically overwriting unused sections of the virtual hard drive or virtual file share with “all zeros”.

In a second aspect, the present invention provides a method of reading and writing data using a data storage server on a host computing system and a data account with a cloud data storage provider, the method comprising the steps of:
receiving, by the host computing system, a write request to write data; storing, by the host computing system, the data on a local cache of the host computing system;
periodically analysing, by the host computing system, the data stored on the local cache and identifying dormant data that has not been accessed for a given period of time;
copying, by the host computer system, the dormant data from the local cache to the data account of the cloud data storage provider over an internet connection;
deleting, by the host computing system, the copied dormant data from the local cache;
flagging, by the host computing system, individual units of the data stored on the local cache as “online” and individual units of the data stored in the data account of the cloud data storage provider as “offline”;
receiving, by the host computing system, a read request to read data; retrieving, by the host computing system, data flagged as “online” from the local cache or data flagged as “offline” from the data account of the cloud data storage provider;
accelerating, by the host computing system, read requests for data flagged as “offline” by read ahead caching;

accelerating, by the host computing system, write requests to dormant data flagged as “offline” by storing delayed write data in the local cache and periodically applying the delayed write data from the local cache to the dormant data by updating the data stored in the data account of the cloud data storage provider and storing the updated data on the local cache.

In a preferred embodiment, the method further comprises the step of:
deleting, by the host computing system, the retrieved data from the data account of the cloud data storage provider after data flagged as “offline” is retrieved from the data account of the cloud data storage provider and stored on the local cache.

Preferably, the method further comprises the step of periodically writing, by the host computing system, “all zeros” to unused parts of the virtual hard drive or virtual file share.

Further preferably, the method further comprises the step of accelerating performance of the data storage server by preventing, by the host computing system, data other than file data from being identified as dormant.

In a preferred embodiment, the method further comprises the additional steps of:
copying, by the host computer system, the dormant data from the local cache to a data storage accelerator on a local hard disk of a local network computer, when the step of copying data to the data account of the cloud data storage provider is performed; and
retrieving, by the host computing system, data flagged as “offline” from the data accelerator on the local hard disk of the local network computer.

Preferably, the dormant data is copied from the local cache to a plurality of data storage accelerators on a plurality of local network computers.

### BRIEF DESCRIPTION OF THE DRAWINGS

A preferred embodiment of the invention will now be described by way of specific example with reference to the accompanying drawings, in which:

FIG. 1 is a schematic diagram of a data storage system;

FIG. 2 is a flowchart depicting a data analysis function of a data management protocol of the data management system of FIG. 1;

FIG. 3 is a flowchart depicting a data write request function of a data management protocol of the data management system of FIG. 1; and

FIG. 4 is a flowchart depicting a data read request function of a data management protocol of the data management system of FIG. 1.

### DETAILED DESCRIPTION OF THE PREFERRED EMBODIMENTS

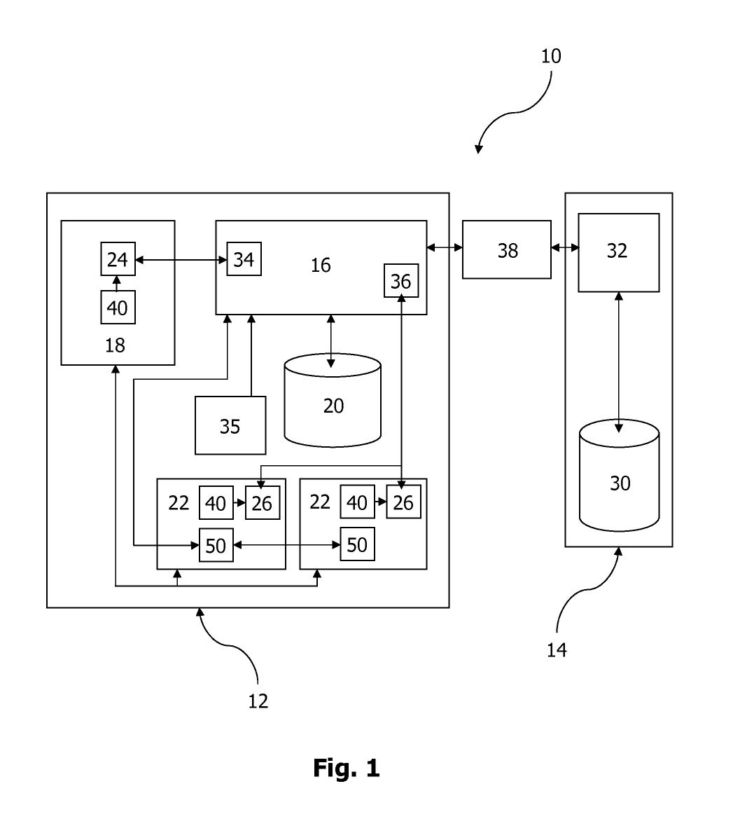

As depicted in FIG. 1, the data storage system 10 manages the storage and retrieval of data for a host computing system 12 using a cloud data storage provider 14.

The host computing system 12 of the data storage system 10 comprises a data storage server 16, a file server 18, a local cache 20 and a plurality of user terminals 22. The user terminals 22 are adapted to access data via either a file based protocol, such as a network file system (NFS) 24, or by a block based protocol, such as Internet Small Computers System Interface (iSCSI). The files or blocks are collectively referred to here as units of data. A virtual hard drive device driver 26 is installed on each user terminal 22.

The data storage server 16 is adapted to communicate via an internet connection with a data account 30 of the cloud data storage provider 14. A web service interface 32 is provided to facilitate communication between the data storage server 16 and the cloud data storage provider 14.

The virtual hard drive device driver 26 is adapted to map a virtual hard drive 36 onto the data storage server 16 of the host computing system 12. The virtual hard drive device driver 26 is a standard block device compatible with the user terminals 22. Requests from the user terminals 22 to read and write data from/to the virtual hard drive 36 are redirected to the data storage server 16.

The network file system 24 installed on the file server 18 is adapted to map a virtual file share 34 onto the data storage server 16 of the host computing system 12. The network file system 24 appears as a standard network file share to the user terminals 22. Requests from user terminals 22 to read and write data from/to the virtual file share 34 are redirected to the data storage server 16.

The data storage server 16 provides concurrent access to each of the virtual hard drives 36 and/or virtual file shares 34 on the local network 12. The data storage server 16 operates according to a data management protocol 35 stored on, and adapted to be employed by, the host computing system 12.

When data is saved to the virtual hard drive 36 from one of the user terminals 22, or saved to the virtual file share 34 on the file server 18, the data management protocol 35 directs the data storage server 16 to initially store the data in the local cache 20. Each data unit is uniquely located within the local cache 20. Data units are flagged by the data storage server 16 as either “online” in the local cache 20 or “offline” in the account 30 of the cloud data storage provider 14.

During downtime or low activity periods for the host computing system 12, such as overnight or on weekends, the data management protocol 35 directs the data storage server 16 to copy the data in the local cache 20 to the data account 30 of the cloud data storage provider 14 via a secure connection 38, such as SSL or VPN. The web service interface 32 facilitates formatting of the data for storage in the data account 30 of the cloud data storage provider 14. All data units in the local cache 20 are checked periodically for usage. Least recently used (or “dormant”) data units are uploaded to the data account 30 of the cloud data storage provider 14, flagged as “offline” and deleted from the local cache 20.

The data storage system 10 further comprises a data storage optimiser 40 provided on a user terminal 22 or on the file server 18. The data storage optimiser 40 has access to the virtual hard drive 36 or virtual file share 34 to optimise the data stored in the local cache 20.

The data storage optimiser 40 periodically reads virtual hard drive 36 or virtual file share 34 metadata including directories, filenames, permissions and attributes in order to maintain that data in the local cache 20. In this way, the data storage optimiser 40 also accelerates performance of the data storage server 16 by preventing data other than file data from being identified as “dormant”. The data storage optimiser 40 also reduces storage requirements of the data storage server 16 by periodically overwriting “all zeros” to unused parts of the virtual hard drive 36. The data storage optimiser 40 is also adapted to periodically run disk checking utilities against the virtual hard drive 36 to prevent important internal file systems data structures from being marked as dormant.

The data storage system 10 further includes data storage accelerators 50, located on a local network computer, such as the user terminals 22, and adapted to utilise hard disk space on the user terminals 22 for data storage, by redundantly storing data that has also been uploaded to the data account 30 of the cloud data storage provider 14.

The data storage accelerators 50 are adapted to process requests to save data by storing the data on the local hard disk of the user terminal 22 and to process requests to delete data by deleting the data from the local hard disk of the user terminal 22.

The data storage accelerators 50 are also adapted to process requests to check for data with a specific hash by:
a) returning a positive acknowledgement to the data storage server 16, if the requested data is stored on the local hard disk and the hash of the data stored on the local hard disk matches the hash of the data requested;
b) deleting the data, if the requested data is stored on the local hard disk and the hash of the data stored on the local hard disk does not match the hash of the data requested.

The data storage accelerators 50 are adapted to process requests to send data with a specific hash by:
a) sending the requested data to the data storage server 16, if the requested data is stored on the local hard disk and the hash of the data stored on the local hard disk matches the hash of the data requested; and
b) deleting the data, if the requested data is stored on the local hard disk and the hash of the data stored on the local hard disk does not match the hash of the data requested.

The data storage accelerators 50 accelerate performance and improve resilience to slowness or unavailability of the cloud data storage provider 14, by redundantly storing the data uploaded to the cloud data storage provider 14. The data storage accelerators 50 also employ the vast amount of unused storage available on the many computers on the local network to accelerate performance and improve resilience.

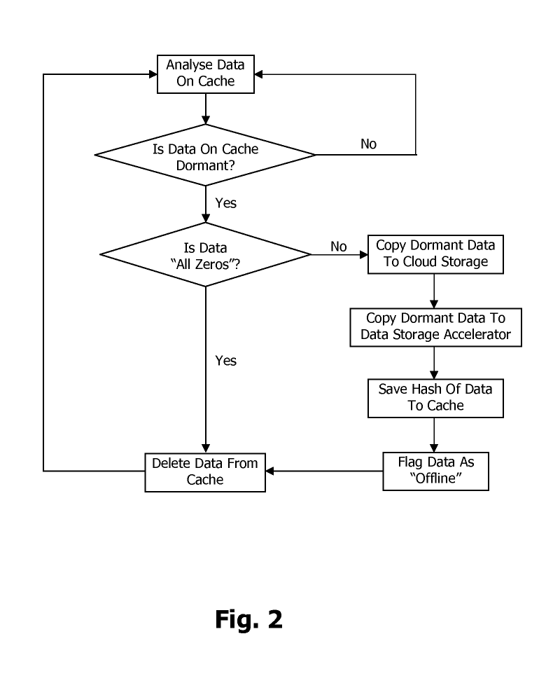

As depicted in FIG. 2, the data management protocol 35 directs the data storage server 16 to periodically analyse the local cache 20 during periods of low activity, identify “dormant” data that has been least recently used and delete “dormant” data that contains “all zeros”. The data management protocol 35 also directs the data storage server 16 to archive “dormant” data that does not contain “all zeros” by:
a) copying the “dormant” data to the data account 30 of the cloud data storage provider 14;
b) copying the “dormant” data to one or more of the data storage accelerators 50;
c) saving the hash, Message Digest Algorithm 5 (MD5), of the “dormant” data in the local cache 20;
d) flagging the “dormant” data as “offline”; and
e) deleting the “dormant” data from the local cache 20.

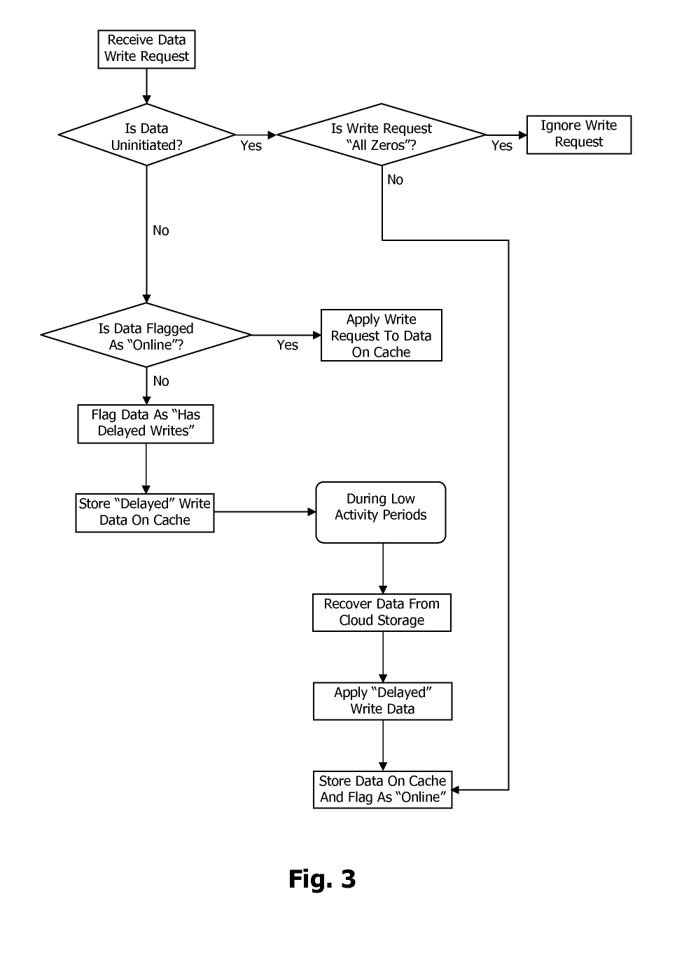

FIG. 3 is a flowchart depicting the data management protocol 35 directing the data storage server 16 to process data write requests. If the write request is in respect of data that is uninitiated, then a write request that is “all zeros” is simply ignored and a write request that is not “all zeros” is stored in the local cache 20 and flagged as “online”. If the write request is in respect of data that is flagged as “online”, then the write request is processed by updating the data in the local cache 20.

Otherwise, if the request is in respect of data that is flagged as “offline”, then the write request is processed by:
a) flagging the data as “has delayed writes” and storing the write data, such as offset, size and data as “delayed” write data in the local cache 20;

then, during periods of low activity:
b) recovering the data flagged as “offline” from the data account 30 of the cloud data storage provider 14;
c) applying the “delayed” write data to the recovered data;
d) storing the data in the local cache 20; and
e) flagging the data as “online”.

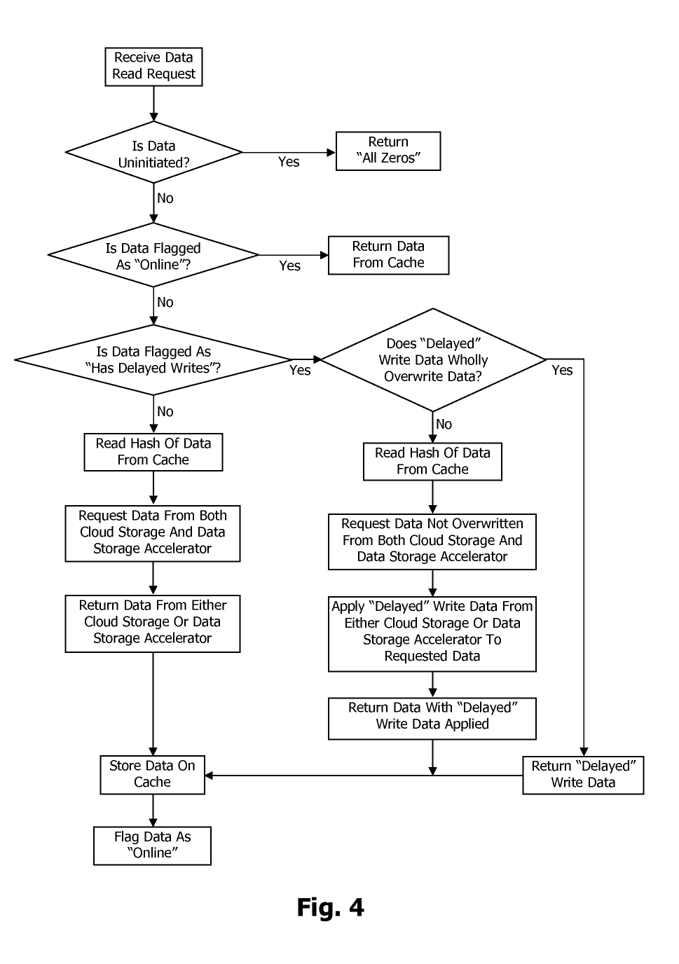

FIG. 4 is a flowchart depicting the data management protocol 35 directing the data storage server 16 to process data read requests. If the read request is in respect of data that is uninitiated, then the data storage server 16 returns data that is “all zeros”. If the read request is in respect of data that is flagged as “online”, then the data storage server 16 returns the data from the local cache 20.

If the read request is in respect of data that is flagged as “offline” and not flagged as “has delayed writes”, then the read request is processed by:
a) reading the hash of the data flagged as “offline” from the local cache 20;
b) requesting the data flagged as “offline” from the cloud data storage provider 14;
c) checking all data storage accelerators 50 to determine if the data flagged as “offline” is stored on a data storage accelerator 50 and if it matches the hash;
d) recovering the data from the first data accelerator 50 that returns a positive acknowledgement or from the cloud data storage provider 14, whichever is fastest;
e) saving the recovered data in the local cache 20; and
f) flagging the data as “online”.

If the read request is in respect of data that is flagged as “offline” and also flagged as “has delayed writes”, then the read request is processed by first determining whether the “delayed” write data wholly overrides the data flagged as “offline”. This is done by:
a) reading the “delayed” write data from the local cache 20;
b) creating a buffer;
c) creating a bitmap;
d) applying all the “delayed” write data to the buffer;
e) applying all the “delayed” write data to the bitmap, but substituting “ones” for the data in the “delayed” write data, so that the bitmap contains “ones” for the parts of the data that have been modified by the “delayed” write data.

If the bitmap is “all ones”, then the “delayed” write data has wholly overwritten the data flagged as “offline”. If the bitmap is not “all ones”, then the data has only partially been overwritten by the “delayed” write data.

If the “delayed” write data wholly overwrites the data, then the read request is processed by returning the buffer created above, saving the buffer in the local cache 20, flagging the data as “online” and unflagging the data as “has delayed writes”.

If the “delayed” write data does not wholly overwrite the data, then the read request is processed by:
a) reading the hash of the data flagged as “offline” from the local cache 20;
b) requesting the data that is not overwritten by the “delayed” write data from the cloud data storage provider 14;
c) checking all data storage accelerators 50 to determine if the data that is not overwritten by the “delayed” write data is stored on a data storage accelerator 50 and if it matches the hash;
d) recovering the data that is not overwritten by the “delayed” write data from the first data accelerator 50 that returns a positive acknowledgement or from the cloud data storage provider 14, whichever is fastest;
e) applying the “delayed” write data to the recovered data;
f) saving the recovered data in the local cache 20; and
g) flagging the data as “online” and unflagging the data as “has delayed writes”.

After data has been recovered from the cloud data storage provider 14 or the data storage accelerators 50, that data can either be immediately deleted or alternatively, the data may be flagged as “to be deleted”. In this case, during periods of low activity, the data flagged as “to be deleted” is deleted from the data account 30 of the cloud data storage provider 14 and any data storage accelerators 50.

In the data storage system 10 of the present invention, the most recently accessed and created data units are stored locally in the local cache 20 or in the data storage accelerators 50 and are accessible at local network speeds. It is only when a dormant data unit needs to be accessed that is not available the data unit must be retrieved from the cloud data storage provider 14 at speeds limited by available bandwidth.

This allows seamless local access to the vast majority of all data required by a typical organisation on a given day, while still maintaining reasonably responsive access to all stored data. Since the local cache 20 requires only a fraction of the total data storage, the data storage system 10 can be installed and operated for a fraction of the cost of installing and operating a data storage system on the local network.

A further advantage of the data storage system 10 is that it allows data to be stored under local protocols on either a virtual drive or a virtual file share on the local network. From a user standpoint, the process is as simple as saving the data to a hard drive or network file share, using standard local formats and protocols. The data storage system 10 manages the appropriate data formatting and communication with the data account 30 of the cloud data storage provider 14.

The data storage system 10 virtualises data storage by allowing a limited amount of physical data storage to appear many times larger than it actually is. Virtualising data storage allows fast, expensive physical data storage to be supplemented by cheaper, slower remote data storage without incurring substantial performance degradation. Virtualising data storage also reduces the physical data storage requirements to a small fraction of the total storage requirements, while the rest of the data can be “offloaded” into slower, cheaper online cloud data storage providers 14.

The data management protocol 35 accelerates performance and reduces the data storage requirements by assuming uninitialized data contains “all zeros”. The data management protocol 35 also reduces the data storage requirements while maintaining performance by moving the least recently used data to the data account 30 of the cloud data storage provider 14 and to one or more of the data storage accelerators 50. The data management protocol 35 accelerates performance by assuming that the data units will be accessed in sequence and by assuming that actual writes to data can happen anytime before a subsequent read to the same data. The data management protocol 35 also accelerates performance by scheduling this “delayed” write data to periods of low activity and by not downloading data from the cloud data storage provider 14 when processing “delayed” write data that has wholly overwritten data. The data management protocol 35 further accelerates performance by assuming that delete operations on data at the cloud data storage provider 14 can happen anytime after the data is downloaded.

Advantageously, the data management protocol 35 increases the apparent availability of the cloud data storage provider 14. If the local cache 20 satisfies 99% of requests for data without requiring the cloud data storage provider 14, the apparent availability of the cloud data storage provider 14 is increased 100 fold and 99% of data accesses occur at local network speeds rather than the network connection speeds to the cloud data storage provider 14. The data management protocol 35 also manages the data formatting and communication with the cloud data storage provider 14 while allowing seamless access to data using standard protocols such as iSCSI and NFS. Further, the data management protocol 35 allows concurrent processing of read and writes requests to different data as well as synchronised and serialised access to concurrent access to the same data.

Although the invention has been described with reference to specific examples, it will be appreciated by those skilled in the art that the invention may be embodied in many other forms.

I claim:

1. A data storage system having:
a host computing system including a data storage server and a local cache, the host computing system having access via an internet connection to a data account with a cloud data storage provider; and
a data management protocol stored on, and adapted to be employed by, the host computing system to direct the data storage server to:
(a) store data to be saved in the local cache;
(b) periodically analyse data on the local cache and identify dormant data that has not been accessed for a given period of time;
(c) copy dormant data to the data account of the cloud data storage provider and delete the copied dormant data from the local cache;
(d) flag individual units of the data as “online” for data units stored in the local cache or “offline” for data units stored in the data account of the cloud data storage provider;
(e) accelerate read requests for data flagged as “offline” by accessing the data from the data account with the cloud data storage provider with read ahead caching; and
(f) accelerate write requests to dormant data flagged as “offline” by storing delayed writes in the local cache and periodically applying the delayed writes to the dormant data by updating the data stored in the data account of the cloud data storage provider and storing the updated data on the local cache.

2. The data storage system of claim 1, further including at least one user terminal and a virtual hard drive device driver installed on the user terminal, the virtual hard drive device driver being adapted to map a virtual hard drive on the data storage server.

3. The data storage system of claim 1, wherein the host computing system includes at least one file server and a network file system installed on the file server, the network file system being adapted to map a virtual file share on the data storage server.

4. The data storage system of claim 1, wherein the data management protocol is adapted to be employed by the host computing system to direct the data storage server to delete accessed data from the data account of the cloud data storage provider when data has been accessed by a read request, stored on the local cache and flagged as “online”.

5. The data storage system of claim 1, wherein the data management protocol is adapted to be employed by the host computing system to direct the data storage server to accelerate read requests for uninitialized data by returning “all zeros”.

6. The data storage system of claim 1, wherein the data management protocol is adapted to be employed by the host computing system to direct the data storage server to accelerate write requests of “all zeros” to uninitialized data by ignoring the request.

7. The data storage system of claim 1, wherein the data management protocol is adapted to be employed by the host computing system to direct the data storage server to accelerate read requests for data flagged as “offline” and having associated delayed write data, by applying the delayed write data from the local cache, flagging the data as “online” and deleting the data from the data account of the cloud data storage provider.

8. The data storage system of claim 1, further comprising a data storage accelerator provided on a local network computer, the data storage accelerator being adapted to process requests from the data storage server to save data by storing the data on a local hard disk of the local network computer and to process subsequent requests to send data by returning the saved data from the local hard disk of the local network computer.

9. The data storage system of claim 8, wherein the data storage accelerator is further adapted to process requests to send or check for data with a specific hash by:
a) returning either the requested data or a positive acknowledgement to the data storage server, if the requested data is stored in the local hard disk and the hash of the data stored in the local hard disk matches the hash of the data requested; and
b) deleting the requested data from the local hard disk, if the requested data is stored in the local hard disk and the hash of the data stored in the local hard disk does not match the hash of the data requested.

10. The data storage system of claim 2, further comprising a data storage optimiser provided on the user terminal and having access to the virtual hard drive to optimise the data stored on the local cache.

11. The data storage system of claim 3, further comprising a data storage optimiser provided on the file server and having access to the virtual file share to optimise the data stored on the local cache.

12. The data storage system of claim 10, wherein the data storage optimiser is adapted to periodically read virtual hard drive or virtual file share metadata including directories, filenames, permissions and attributes.

13. The data storage system of claim 10, wherein the data storage optimiser is adapted to accelerate performance of the data storage server by preventing data other than file data from being identified as dormant.

14. The data storage system of claim 10, wherein the data storage optimiser is adapted to reduce storage requirements of the data storage server by periodically overwriting unused sections of the virtual hard drive or virtual file share with “all zeros”.

15. A method of reading and writing data using a data storage server on a host computing system and a data account with a cloud data storage provider, the method comprising the steps of:
receiving, by the host computing system, a write request to write data;
storing, by the host computing system, the data on a local cache of the host computing system;
periodically analysing, by the host computing system, the data stored on the local cache and identifying dormant data that has not been accessed for a given period of time;
copying, by the host computer system, the dormant data from the local cache to the data account of the cloud data storage provider over an internet connection;
deleting, by the host computing system, the copied dormant data from the local cache;
flagging, by the host computing system, individual units of the data stored on the local cache as “online” and individual units of the data stored in the data account of the cloud data storage provider as “offline”;
receiving, by the host computing system, a read request to read data;
retrieving, by the host computing system, data flagged as “online” from the local cache or data flagged as “offline” from the data account of the cloud data storage provider;
accelerating, by the host computing system, read requests for data flagged as “offline” by read ahead caching;
accelerating, by the host computing system, write requests to dormant data flagged as “offline” by storing delayed write data in the local cache and periodically applying the delayed write data from the local cache to the dormant data by updating the data stored in the data account of the cloud data storage provider and storing the updated data on the local cache.

16. The method of claim 15, further comprising the step of:
deleting, by the host computing system, the retrieved data from the data account of the cloud data storage provider after data flagged as “offline” is retrieved from the data account of the cloud data storage provider and stored on the local cache.

17. The method of claim 15, further comprising the step of periodically writing, by the host computing system, “all zeros” to unused parts of the virtual hard drive or virtual file share.

18. The method of claim 15, further comprising the step of accelerating performance of the data storage server by preventing, by the host computing system, data other than file data from being identified as dormant.

19. The method of claim 15, further comprising the additional steps of:
copying, by the host computer system, the dormant data from the local cache to a data storage accelerator on a local hard disk of a local network computer, when the step of copying data to the data account of the cloud data storage provider is performed; and
retrieving, by the host computing system, data flagged as “offline” from the data accelerator on the local hard disk of the local network computer.

20. The method of claim 19, wherein the dormant data is copied from the local cache to a plurality of data storage accelerators on a plurality of local network computers.
